(19) United States
(12) Patent Application Publication
(10) Pub. No.: US 2026/0321812 A1
(43) Pub. Date: Oct. 15, 2026

(54) METHOD FOR PARTIALLY ANODIZING A BATTERY CELL

(71) Applicant: GM Global Technology Operations LLC, Detroit, MI (US)

(72) Inventors: Xingcheng Xiao, Troy, MI (US); Seung-Woo Chu, Sterling Heights, MI (US); William Yu Chen, Troy, MI (US); Roshan Kandanda, Sterling Heights, MI (US)

(21) Appl. No.: 19/177,970

(22) Filed: Apr. 14, 2025

(51) Int. Cl. H01M 50/119; B60L 50/64; H01M 10/613; H01M 10/625; H01M 10/647; H01M 10/6554; H01M 50/103; H01M 50/143; H01M 50/15; H01M 50/169; H01M 50/209; H01M 50/249

(52) U.S. Cl. CPC H01M 50/119; B60L 50/64; H01M 10/613; H01M 10/625; H01M 10/647; H01M 10/6554; H01M 50/103; H01M 50/143; H01M 50/15; H01M 50/169; H01M 50/209; H01M 50/249; H01M 2220/20

(57) ABSTRACT

A battery pack for use in a vehicle includes a plurality of prismatic battery cells. The plurality of prismatic battery cells includes a cell enclosure for an anode, a cathode, a separator, and an electrolyte. The cell enclosure includes at least one side wall including a first end and a second end opposing the first end; a bottom wall connected to the first end defining a volume, an interior surface of the cell enclosure, and an exterior surface of the cell enclosure; and a top cap mate-able to the second end. At least one of the side wall, the bottom wall, and the top cap is formed of aluminum and anodized. The battery pack further includes a thermal interface material (TIM) having a top surface and a bottom surface, the bottom surface opposing the top surface. The battery pack further includes a cold plate.

### INTRODUCTION

The present disclosure relates to a method for partially anodizing a battery cell. More particularly, the present disclosure relates to a method for partially anodizing a prismatic battery cell to form an electrically insulating, thermally conductive, thermally stable, and mechanically wear-resistant layer.

Electric and hybrid electric vehicle technology is enabled by the development and deployment of rechargeable, secondary batteries, which provide energy to the vehicle powertrain. Secondary batteries include a prismatic battery cell, which generally include a cathode, an anode, a separator, and an electrolyte. During charging of the prismatic battery cell, ions move from the cathode to the anode. The ions are stored in the anode and are released, returning to the cathode when energy is needed. The separator prevents the cathode and the anode from contacting and shorting out the battery. The electrolyte provides a medium between the cathode and the anode through which the ions travel.

Prismatic battery enclosures are often formed from aluminum. This leads to a need to prevent shorting and arcing issues within and between the battery cells. Polymer materials are often used as insulators to prevent shorting, such as using polyphenylene sulfide (PPS) in a top cap of the prismatic battery cell and using a polyethylene terephthalate (PET) film around the prismatic battery cell enclosure. However, adding the polymer materials to the prismatic battery cell increases the thickness of each prismatic battery cell. In addition, use of the PET hinders heat dissipation due to the PET's low thermal conductivity. The PET film also traps moisture, which can negatively affect the integrity of the prismatic battery enclosure.

Thus, while current methods for insulating the prismatic battery cell by wrapping the prismatic battery cell with the PET film achieves its intended purpose, there is a need for a new and improved method for improving battery insulation and facilitating heat dissipation while decreasing the thickness of each prismatic battery cell, such as partially anodizing the prismatic battery cell.

### SUMMARY

According to several aspects, a battery pack for use in a vehicle is provided. The battery pack includes a plurality of prismatic battery cells. The plurality of prismatic battery cells includes a cell enclosure for an anode, a cathode, a separator, and an electrolyte. The cell enclosure includes at least one side wall including a first end and a second end. The cell enclosure further includes a bottom wall connected to the first end of the at least one side wall defining a volume, an interior surface of the cell enclosure, and an exterior surface of the cell enclosure. The cell enclosure further includes a top cap mate-able to the second end of the at least one side wall. At least one of the at least one side wall, the bottom wall, and the top cap is formed of aluminum and anodized. The battery pack further includes a thermal interface material (TIM). The TIM has a top surface and a bottom surface, the bottom surface opposing the top surface. The top surface is adjacent to the bottom wall of the cell enclosure. The battery pack further includes a cold plate. The cold plate is adjacent to the bottom surface of the TIM.

In an additional aspect of the present disclosure, the exterior surface is formed of aluminum and a portion of the exterior surface of the cell enclosure is anodized.

In another aspect of the present disclosure, the exterior surface of the second end of the at least one side wall is un-anodized. The un-anodized second end of the at least one side wall is mated to the top cap by laser welding.

In another aspect of the present disclosure, the exterior surface of the bottom wall is anodized and is directly in contact with the TIM.

In another aspect of the present disclosure, the exterior surface of the at least one side wall of the plurality of prismatic battery cells is anodized and is directly in contact with the at least one side wall of an adjacent prismatic battery cell.

In another aspect of the present disclosure, the top cap is formed of aluminum and a center of the top cap is anodized. An edge of the top cap is un-anodized. The un-anodized edge of the top cap is mated to the at least one side wall by laser welding.

In another aspect of the present disclosure, the cell enclosure further includes an anodized layer. The anodized layer is dense.

In another aspect of the present disclosure, the cell enclosure further comprises an anodized layer. The anodized layer is porous and includes pores. The pores are filled with one of the following: a fire retardant, a thermal conductive agent, and a TIM epoxy.

According to several aspects, a prismatic battery cell for a vehicle is provided. The prismatic battery cell includes a cell enclosure for an anode, a cathode, a separator, and an electrolyte. The cell enclosure includes at least one side wall including a first end and a second end opposing the first end. The cell enclosure further includes a bottom wall connected to the first end of the at least one side wall defining a volume, an interior surface of the cell enclosure, and an exterior surface of the cell enclosure. The cell enclosure further includes a top cap mate-able to the second end of the at least one side wall. At least one of the at least one side wall, the bottom wall, and the top cap is formed of aluminum and anodized.

In another aspect of the present disclosure, the interior surface is formed of aluminum and a portion of the interior surface of the cell enclosure is anodized.

In another aspect of the present disclosure, the interior surface of the second end of the at least one side wall is un-anodized. The un-anodized second end of the at least one side wall is mated to the top cap by laser welding.

In another aspect of the present disclosure, the exterior surface is formed of aluminum and a portion of the exterior surface of the cell enclosure is anodized.

In another aspect of the present disclosure, the exterior surface of the second end of the at least one side wall is un-anodized. The un-anodized second end of the at least one side wall is mated to the top cap by laser welding.

In another aspect of the present disclosure, the top cap is formed of aluminum and a center of the top cap is anodized. An edge of the top cap is un-anodized. The un-anodized edge of the top cap is mated to the at least one side wall by laser welding.

According to several aspects, a method for anodizing a cell enclosure is provided. The method includes forming a cell can for the cell enclosure. The cell enclosure includes at least one side wall including a first end and a second end opposing the first end. The cell enclosure further includes a bottom wall connected to the first end of the at least one side wall defining a volume, an interior surface of the cell enclosure, and an exterior surface of the cell enclosure. The cell enclosure further includes a top cap mate-able to the second end of the at least one side wall. At least one of the at least one side wall, the bottom wall, and the top cap is formed of aluminum and anodized. The method further includes covering a portion of the cell enclosure with an acid. The method further includes applying a power source to the cell enclosure, anodizing the covered portion of the cell enclosure.

In another aspect of the present disclosure, where covering a portion of the exterior surface of the cell enclosure with the acid. The exterior surface is formed of aluminum and the portion of the exterior surface is anodized.

In another aspect of the present disclosure, covering a portion of the interior surface of the cell enclosure includes filling the volume defined by the cell enclosure with the acid. The interior surface is formed of aluminum and the portion of the interior surface is anodized.

In another aspect of the present disclosure, the method further includes masking a portion of the cell enclosure prior to covering the portion of the cell enclosure with the acid.

In another aspect of the present disclosure, masking an edge of the top cap and anodizing a center of the top cap. The top cap is formed of aluminum. The edge of the top cap is un-anodized. The method further includes removing the masking and welding the un-anodized edge of the top cap to the at least one side wall of the cell enclosure

In another aspect of the present disclosure, the method further includes removing any masking from the portion of the cell enclosure and welding the top cap to the at least one side wall.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1A illustrates a vehicle including a battery pack with a plurality of prismatic battery cells according to an exemplary embodiment.

FIG. 1B illustrates an enlarged view of the battery pack with a plurality of prismatic battery cells according to an exemplary embodiment.

FIG. 2A illustrates the prismatic battery cell according to an exemplary embodiment.

FIG. 2B illustrates an exploded view of a top cap of the prismatic battery cell according to an exemplary embodiment.

FIG. 3 illustrates an isometric view of the prismatic battery cell with an anodized portion of an exterior surface of the prismatic battery cell, particularly anodizing a bottom wall and a height of at least one side wall, according to an exemplary embodiment.

FIG. 4 illustrates an isometric view of the prismatic battery cell with an alternate anodized portion of the exterior surface of the prismatic battery cell according to an exemplary embodiment.

FIG. 5 illustrates an isometric view of the prismatic battery cell with an anodized portion of an interior surface of the prismatic battery cell according to an exemplary embodiment.

FIG. 6 illustrates a top view of the prismatic battery cell with an anodized portion of the top cap according to an exemplary embodiment.

FIG. 7A illustrates an anodized prismatic battery cell with a porous anodized layer according to an exemplary embodiment.

FIG. 7B illustrates an anodized prismatic battery cell with a dense anodized layer according to an exemplary embodiment.

FIG. 8 illustrates a method for anodizing a portion of the prismatic battery cell.

### DETAILED DESCRIPTION

The following description is merely exemplary in nature and is not intended to limit the present disclosure, application, or uses. Furthermore, there is no intention to be bound by any expressed or implied theory presented in the preceding introduction, summary, or the following detailed description. It should be understood that throughout the drawings, corresponding reference numerals indicate like or corresponding parts and features.

Reference will now be made in detail to several examples of the disclosure that are illustrated in accompanying drawings. Whenever possible, the same or similar reference numerals are used in the drawings and the description to refer to the same or like parts or steps. The drawings are in simplified form and are not to precise scale.

The present disclosure relates to a method for partially anodizing a battery cell. More particularly, the present disclosure relates to a method for partially anodizing a prismatic battery cell to form an electrically insulating, thermally conductive, thermally stable, and mechanically wear-resistant layer. The prismatic battery cell may be used in electric or hybrid-electric vehicles.

As used herein, the term “vehicle” is not limited to automobiles. While the present technology is described primarily herein in connection with electric and hybrid-electric vehicles, the technology is not limited to electric and hybrid-electric vehicles. The concepts can be used in a wide variety of applications, such as in connection with components used in motorcycles, mopeds, locomotives, aircraft, marine craft, and other vehicles, as well as in other applications utilizing batteries, such as consumer electronics, power banks for buildings, and portable power stations used for powering remote job sites, emergency back-up power supplies, and permanent power stations associated with buildings and equipment, all of which may be powered by, for example, solar or wind-powered generator systems, power mains, and fuel based power generators such as gasoline, propane, kerosene, or diesel generators as well as sterling engines.

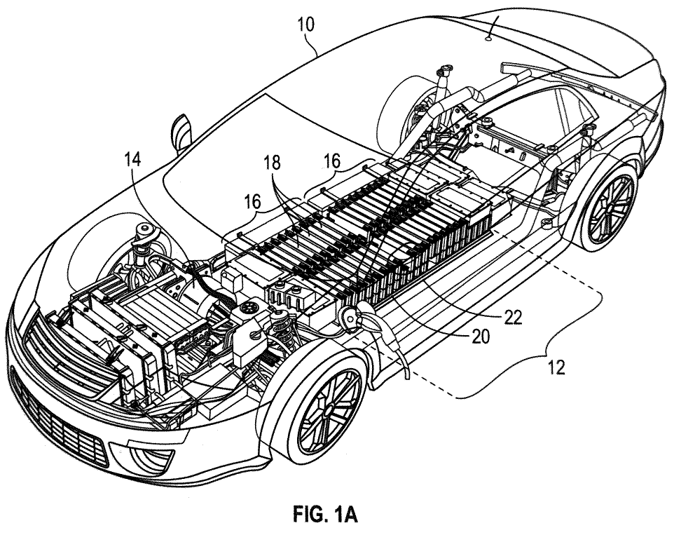

Referring to FIG. 1A, a vehicle 10 including a battery pack 12 for providing power to an electric motor 14 is illustrated. The battery pack 12 includes a plurality of battery modules 16 that are electrically connected to one another. Each battery module 16 includes a plurality of prismatic battery cells 18 disposed within the battery module 16. The battery pack 12 also includes a thermal interface material (TIM) 20 and a cold plate 22.

An enlarged view of the battery pack 12, including the TIM 20 and the cold plate 22 is shown in FIG. 1B. The TIM 20 and the cold plate 22 assist in managing temperatures of the plurality of prismatic battery cells 18 within the battery pack 12. The TIM 20 is positioned between the plurality of prismatic battery cells 18 and the cold plate 22. A top surface 24 of the TIM 20 is adjacent to the prismatic battery cell 18 and a bottom surface 26 opposes the top surface 24 and is adjacent to the cold plate 22. The TIM 20 may be in the form of, but is not limited to, compressible thermal pads, liquid-dispensed and curing adhesives, non-curing gels, and greases. Additionally, the TIM 20 may be formulated from silicones, polyurethanes, epoxies, and acrylics. The TIM 20 assists in transferring the heat generated by the prismatic battery cells 18 to the cold plate 22. The cold plate 22 absorbs the heat from the prismatic battery cell 18 through the TIM 20 and maintains an optimal temperature range for performance and safety of the plurality of prismatic battery cells 18.

Referring back to FIG. 1A, it is to be appreciated that FIG. 1A is merely exemplary in nature, and the plurality of battery modules 16 are not limited to being employed as a secondary battery for a vehicle. Indeed, the battery modules 16 may be used in a variety of other electromobility and stationary applications. It is also to be appreciated that although the vehicle 10 is illustrated as a sedan, the vehicle 10 may be any type of vehicle such as, but not limited to, a truck, sport utility vehicle, van, or motor home.

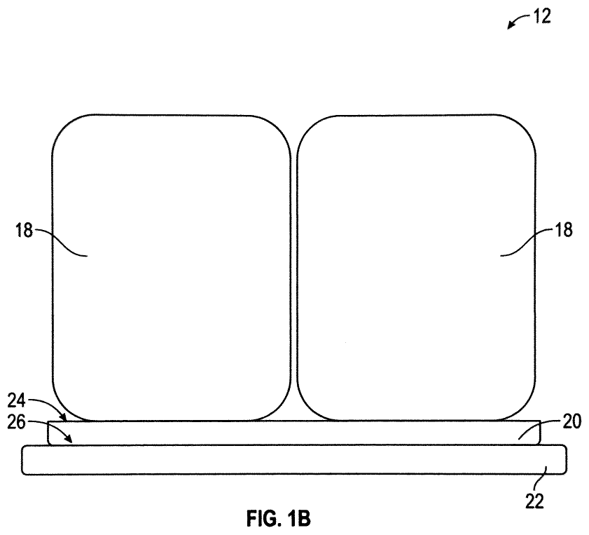

Referring to FIG. 2A, one of the plurality of prismatic battery cells 18 for powering the vehicle 10 (shown in FIG. 1A) is illustrated. It should be appreciated that each of the plurality of prismatic battery cells 18 is identical, and therefore only one of the prismatic battery cells 18 will be described herein. The prismatic battery cell 18 includes an anode 28, a cathode 30, a separator 32, an electrolyte 34, and a cell enclosure 36.

As noted above, the prismatic battery cell 18 is a type of secondary battery, which is understood as a rechargeable battery. The prismatic battery cell 18 may be discharged upon application of a load and recharged upon the application of an external power source. The electric motor 14 (shown in FIG. 1A) creates the load applied to the prismatic battery cell 18, causing ions to move from the anode 28 to the cathode 30 through the separator 32 by way of the electrolyte 34. While applying an external voltage, ions move from the cathode 30 to the anode 28 by way of the electrolyte 34 through the separator 32. The movement of the ions through the electrolyte 34 generates electrical energy. The ions may be stored in the anode 28. The anode 28 releases the ions, returning to the cathode 30, when energy is needed. The anode 28, the cathode 30, the separator 32, and the electrolyte 34 are contained within the cell enclosure 36 to prevent leakage.

The cell enclosure 36 may be formed of aluminum and includes a cell can 38 and a top cap 40. The cell can 38 includes a bottom wall 41 and at least one side wall 42. The bottom wall 41 is connected to a first end 44 of the at least one side wall 42, defining a volume, an exterior surface 46 of the cell enclosure 36, and an interior surface 48 of the cell enclosure 36. The exterior surface 46 of the bottom wall 41 may be in direct contact with the top surface 24 of the TIM 20 (shown in FIG. 1B) and the exterior surface 46 of the at least one side wall 42 may be in direct contact with adjacent prismatic battery cells 18. The interior surface 48 is adjacent to the anode 28, the cathode 30, the separator 32, and the electrolyte 34. For the anode 28, the cathode 30, the separator 32, and the electrolyte 34 to be enclosed within the cell enclosure, the top cap 40 is mated to a second end 58 of the at least one side wall 42. The second end 58 opposes the first end 44 of the at least one side wall 42.

FIG. 2B illustrates an exploded view of the top cap 40 of the prismatic battery cell 18 (shown in FIG. 2A). The top cap 40 has a layered structure including a positive terminal plate 60, a negative terminal plate 62, a plurality of terminal insulators 64, a vent 66, a cap 68, a cap insulator 70, a plurality of gaskets 72, and a plurality of spacers 74.

The positive terminal plate 60 and the negative terminal plate 62 may be formed of, but are not limited to, aluminum. The positive terminal plate 60 provides a positive connection point for external electrical contacts. The negative terminal plate 62 provides a negative connection point for external electrical contacts. The electrical motor 14 (shown in FIG. 1A) is connected to both the positive terminal plate 60 and the negative terminal plate 62, creating a closed circuit. The closed circuit allows the electrons to flow from the negative terminal plate 62 through the electric motor 14 and to the positive terminal plate 60, transforming electrical energy to mechanical energy.

The plurality of terminal insulators 64 are positioned between and are in direct contact with the positive terminal plate 60, the negative terminal plate 62, and the cap 68. The plurality of terminal insulators 64 may be formed of, but are not limited to, polyphenylene sulfide (PPS). The plurality of terminal insulators 64 ensures electrical insulation between the positive terminal plate 60 and the negative terminal plate 62, preventing shorting of the prismatic battery cell 18.

The vent 66 and the cap 68 may be formed of, but are not limited to, aluminum. The vent 66 allows for pressure within the prismatic battery cell 18 to be released. The vent 66 is attached to the cap 68. The cap 68 is the portion of the top cap 40 that is welded to the second end 58 of the at least one side wall 42 (shown in FIG. 2A) and provides structural support and protection for the prismatic battery cell 18.

The cap insulator 70, the plurality of gaskets 72, and the plurality of spacers 74 may be formed of, but are not limited to, PPS. The cap insulator 70 is positioned between the cap 68 and the plurality of gaskets 72. The cap insulator 70 creates a layer of insulation to separate the cap 68 from the anode 28, the cathode 30, and the electrolyte 34 within the prismatic battery cell 18. The plurality of gaskets 72 is positioned between the cap insulator 70 and the plurality of spacers 74. The plurality of gaskets 72 creates a seal to prevent the electrolyte 34 from leaking. The plurality of spacers 74 maintains the cap 68 in proper alignment and separates the cap 68 from the anode 28, the cathode 30, and the electrolyte 34.

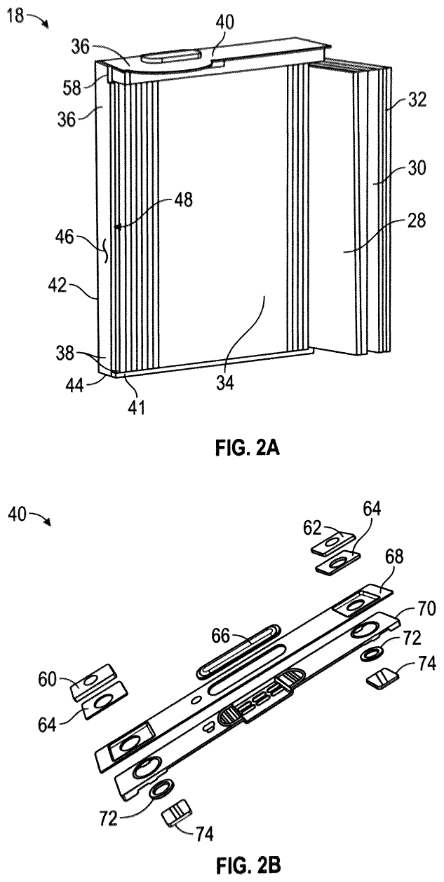

At least a portion of the cell enclosure 36 of the prismatic battery cell 18 is anodized. In embodiments, the anodized portion of the battery cell is formed of aluminum. Referring to FIG. 3, an embodiment of an anodized portion 76 of the exterior surface 46 of the prismatic battery cell 18 is illustrated. The anodized portion 76 is formed by anodizing the exterior surface 46 of the bottom wall 41 and a height 78 of the exterior surface 46 of the at least one side wall 42. The exterior surface 46 of the bottom wall 41 may have curved corners 80 connecting to the first end 44 of the at least one side wall 42. The curved corners 80 have a radius of curvature and a height 78 determined by the radius of curvature, ensuring that the entire exterior surface 46 of the bottom wall 41 is anodized. The exterior surface 46 of the bottom wall 41 may be color anodized. The color anodization may represent different cell chemistry and may allow for visual anodization checks.

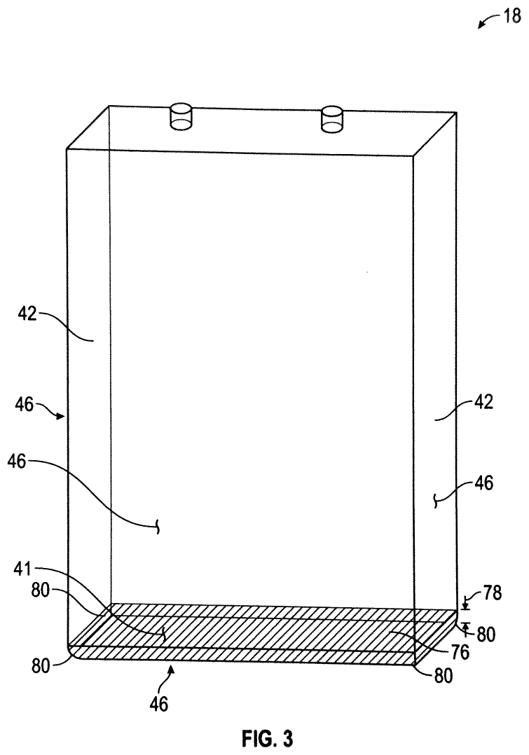

Referring to FIG. 4, an alternate or additional anodized portion 76 of the exterior surface 46, indicated by reference number 82, of the prismatic battery cell 18 is illustrated. The anodized portion 82 is formed by anodizing the exterior surface 46 of the bottom wall 41 and a portion of the exterior surface 46 of the at least one side wall 42. The anodized portion 82 of the exterior surface 46 may be color anodized. The color anodization may represent different cell chemistry and may allow for visual anodization checks. The second end 58 of the at least one side wall 42 remains un-anodized, allowing for the second end 58 to be mated to the top cap 40, through the use of laser welding or other welding processing.

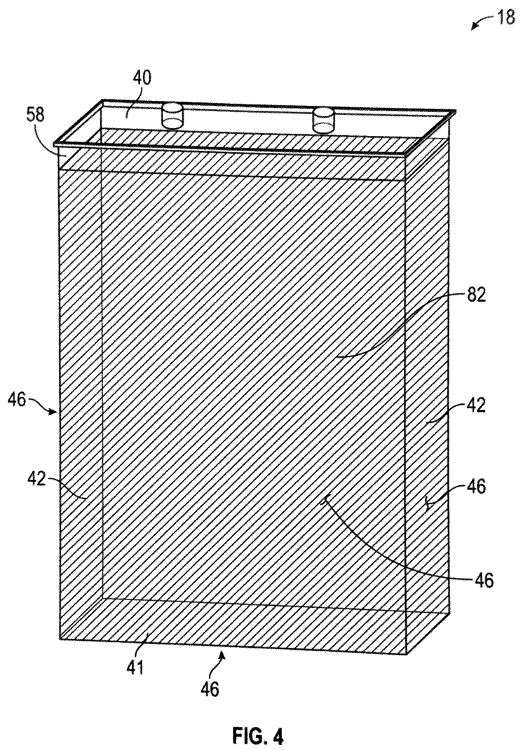

Referring to FIG. 5, an anodized portion 84 of the interior surface 48 of the prismatic battery cell 18 is illustrated. The anodized portion 84 is formed by anodizing the interior surface 48 of the bottom wall 41 and the interior surface 48 of the at least one side wall 42. The second end 58 of the at least one side wall 42 remains un-anodized, allowing the second end 58 to be mated to the top cap 40, through the use of laser welding other welding processing.

FIGS. 3-5 illustrate alternate or additional anodized portions 76, 82, and 84 of the bottom wall 41 and the at least one side wall 42 of the prismatic battery cell 18. Anodizing the prismatic battery cell 18 improves electrical insulation properties during thermal runaway propagation (TRP) and creates a higher resistivity (>1.1014 Ω). With the improved electrical insulation, a polyethylene terephthalate (PET) film is not needed to cover the exterior surface 46 of the prismatic battery cell 18. This allows the exterior surface 46 of the bottom wall 41 to be in direct contact with the top surface 24 of the TIM 20 (shown in FIG. 1B) and allows the exterior surface 46 of the at least one side wall 42 to be in direct contact with adjacent prismatic battery cells 18 (shown in FIG. 1B). Additionally, removing the PET film decreases the thickness of each prismatic battery cell 18, allowing for a higher density of prismatic battery cells 18 in a similar battery pack volume.

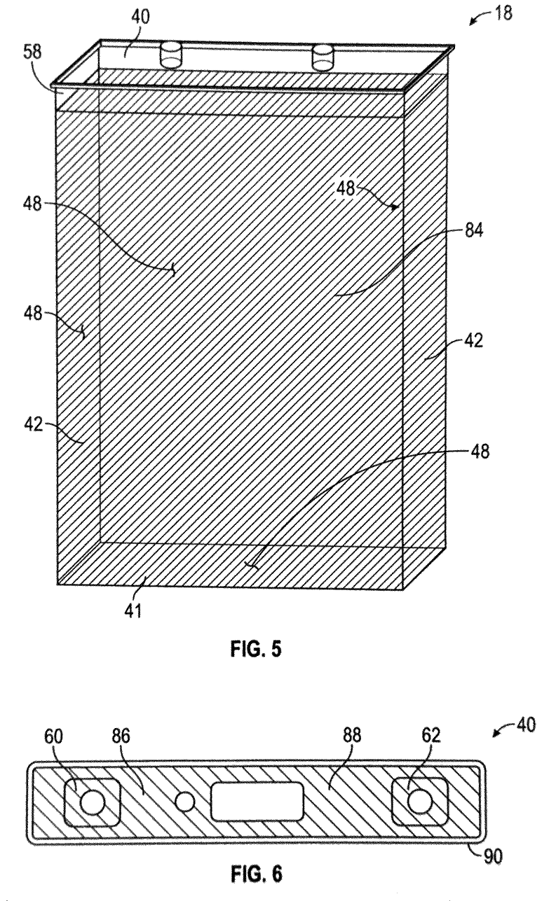

Referring to FIG. 6, an anodized portion 86 of the top cap 40 of the prismatic battery cell 18 is illustrated. The top cap 40 includes a center 88 and an edge 90. The center 88 of the top cap has undergone the anodization process. The edge 90 is un-anodized, enabling the top cap 40 to be mated to the second end 58 of the at least one side wall 42 through the use of laser welding or other welding processing. Anodizing the anodized portion 86 of the top cap 40 enhances the thermomechanical properties and electrical insulation around the positive terminal plate 60 and negative terminal plate 62, where temperature is typically higher. Additionally, anodizing the anodized portion 86 suppresses arcing between the positive terminal plate 60 and the negative terminal plate 62 and grounds the cell enclosure 36.

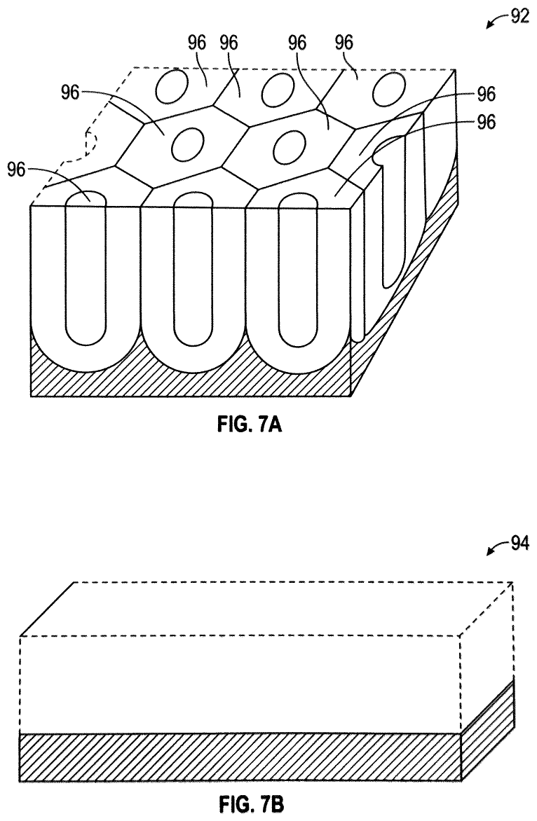

Referring to FIGS. 7A and 7B, an anodized layer 92, 94 on a prismatic battery cell 18 is illustrated. The anodized layer 92, 94 is a layer on the anodized portion 76, 82, 84, and 86 (shown in FIGS. 3-6) of the prismatic battery cell 18. The anodization process to create the anodized portion 76, 82, 84, and 86 is described in further detail below.

After the anodization process, the anodized layer 92 shown in FIG. 7A is porous. The anodized layer 92 exhibits a thickness in the range of 100 nanometers (nm) to 100 micrometers (μm) including all values and ranges therein. The anodized layer 92 exhibits a porosity range of about 5% to 50%, wherein the porosity is understood as the percentage of void volume in a total given volume defined by the anodized layer. The porosity of the anodized layer 92 improves stability of the prismatic battery cell 18. The prismatic battery cell 18 may be formed of aluminum and the aluminum becomes anodic aluminum oxide (AAO), developing a porous layer and forming pores 96. The pores 96 may be filled with chemicals such as a thermal conductive agent, a TIM epoxy, or a fire retardant. The fire retardant may be, but is not limited to, triethyl phosphate (TEP), trimethyl phosphate (TMP), triphenyl phosphate (TPP), or dimethyl methylphosphonate (DMMP). The thermal conductive agent, the TIM epoxy, or the fire retardant are released from the pores 96 during the initial stage of TRP in a prismatic battery cell 18, mitigating the escalation of TRP.

Referring to FIG. 7B, an alternate to anodized layer 92, or additional anodized layer, indicated by reference number 94, on a prismatic battery cell 18 is illustrated. The anodized layer 94 exhibits a thickness in the range of 100 nm to 100 μm, including all values and ranges therein. The anodized layer 94 is dense, having a porosity range of about 1% to 10%. To create the anodized layer 94, the anodized layer 94 undergoes a sealing process after the anodization process. For example, the prismatic battery cell 18 may be formed of aluminum. The aluminum becomes AAO after undergoing the anodization process, which is originally porous. The AAO may then be immersed into a sealing solution to become dense, creating the anodized layer 94. The dense anodized layer 94 improves corrosion resistance and facilitates heat transfer between the prismatic battery cell 18 and the cold plate 22.

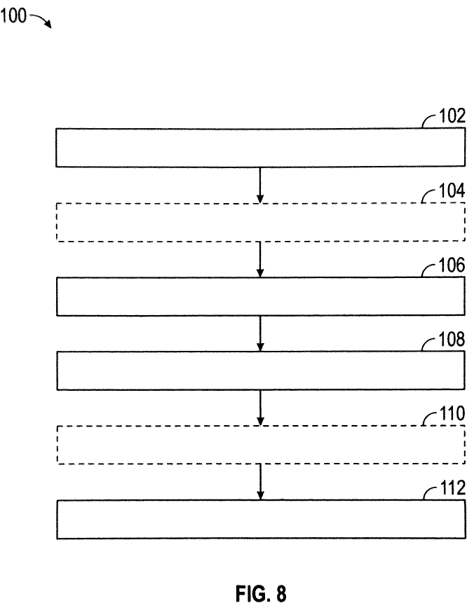

Referring to FIG. 8, a flowchart of a method 100 for anodizing a portion of the cell enclosure 36 is illustrated. At step 102, the cell can 38 of the battery cell 18 is formed. The cell can 38 is formed by connecting the bottom wall 41 to the first end 44 of the at least one side wall 42.

At step 104, a mask may be attached to the cell enclosure 36. For example, the mask may be attached to the edge 90 of the top cap 40. The mask prevents the portion of the cell enclosure 36, where the mask is attached, from anodizing. The mask may be, but is not limited to, a glue or a tape.

At step 106, a portion of the cell enclosure 36 is covered with an acid. The acid may be sulfuric acid. To cover the portion of the cell enclosure 36 with the acid, a bath may be created. With the bath, a portion of the cell enclosure 36 or the top cap 40 may be submerged in the acid. For example, the exterior surface 46 of the bottom wall 41 and the height 78 of the at least one side wall 42 may be submerged in the acid. In an alternate example, the exterior surface 46 of the bottom wall 41 and the exterior surface 46 of the at least one side wall 42 may be submerged in the acid, leaving the second end 58 of the at least one side wall 42 outside of the acid. In yet another alternate example, the top cap 40, with the mask attached to the edge 90, may be fully submerged into the acid bath, preventing the edge 90 from being in contact with the acid. Alternatively, the acid may be used to fill the volume defined by the cell enclosure 36. The interior surface 48 of the second end 58 of the at least one side wall 42 is not in contact with the acid.

At step 108, a power source is applied to the portion of the cell enclosure 36 covered in the acid. The covered portion of the cell enclosure 36 is connected to a positive terminal. An inert material is added to the acid and the negative terminal is connected to the inert material. The electric current flows from the positive terminal, through the cell enclosure 36, through the acid, and to the negative terminal, anodizing the portion of the cell enclosure 36 covered in the acid. The cell enclosure 36 may be formed of aluminum, creating AAO after the anodization process.

At step 110, if a mask is attached to the cell enclosure 36 in step 104, the mask is removed. When the mask is removed, the portion covered by the mask remains un-anodized.

At step 112, the edge 90 of the top cap 40 is mated to the second end 58 of the at least one side wall 42. Both the edge 90 of the top cap 40 and the second end 58 of the at least one side wall 42 are un-anodized to be mated together. The edge 90 and the second end 58 may be mated by using laser welding.

The method 100 for partially anodizing the cell enclosure 36 of the present disclosure offers several advantages. These include improving electrical insulation properties and creating a higher resistivity while decreasing the thickness of each prismatic battery cell 18.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A battery pack for use in a vehicle, the battery pack comprising:
a plurality of prismatic battery cells disposed within the battery pack, wherein the plurality of prismatic battery cells including:
a cell enclosure for an anode, a cathode, a separator, and an electrolyte, the cell enclosure including:
at least one side wall including a first end and a second end opposing the first end;
a bottom wall connected to the first end of the at least one side wall defining a volume, an interior surface of the cell enclosure, and an exterior surface of the cell enclosure; and
a top cap mate-able to the second end of the at least one side wall, and
wherein at least one of the at least one side wall, the bottom wall, and the top cap is formed of aluminum and anodized;
a thermal interface material (TIM), wherein the TIM has a top surface and a bottom surface, the bottom surface opposing the top surface, and wherein the top surface is adjacent to the bottom wall of the cell enclosure; and
a cold plate, wherein the cold plate is adjacent to the bottom surface of the TIM.

2. The battery pack of claim 1, wherein the exterior surface is formed of aluminum and a portion of the exterior surface of the cell enclosure is anodized.

3. The battery pack of claim 2, wherein the exterior surface of the second end of the at least one side wall is un-anodized and wherein the un-anodized second end of the at least one side wall is mated to the top cap by laser welding.

4. The battery pack of claim 2, wherein the exterior surface of the bottom wall is anodized and is directly in contact with the TIM.

5. The battery pack of claim 2, wherein the exterior surface of the at least one side wall of the plurality of prismatic battery cells is anodized and is directly in contact with the at least one side wall of an adjacent prismatic battery cell.

6. The battery pack of claim 1, wherein the top cap is formed of aluminum and a center of the top cap is anodized, wherein an edge of the top cap is un-anodized, and wherein the un-anodized edge of the top cap is mated to the at least one side wall by laser welding.

7. The battery pack of claim 1, wherein the cell enclosure further comprises an anodized layer and wherein the anodized layer is dense.

8. The battery pack of claim 1, wherein the cell enclosure further comprises an anodized layer, wherein the anodized layer is porous, wherein the anodized layer includes pores, wherein the pores are filled with one of the following: a fire retardant, a thermal conductive agent, and a TIM epoxy.

9. A prismatic battery cell for a vehicle, the prismatic battery cell comprising:
a cell enclosure for an anode, a cathode, a separator, and an electrolyte, the cell enclosure including:
at least one side wall including a first end and a second end opposing the first end;
a bottom wall connected to the first end of the at least one side wall defining a volume, an interior surface of the cell enclosure, and an exterior surface of the cell enclosure; and
a top cap mate-able to the second end of the at least one side wall, and
wherein at least one of the at least one side wall, the bottom wall, and the top cap is formed of aluminum and anodized.

10. The prismatic battery cell of claim 9, wherein the interior surface is formed of aluminum and a portion of the interior surface of the cell enclosure is anodized.

11. The prismatic battery cell of claim 10, wherein the interior surface of the second end of the at least one side wall is un-anodized and wherein the un-anodized second end of the at least one side wall is mated to the top cap by laser welding.

12. The prismatic battery cell of claim 9, wherein the exterior surface is formed of aluminum and a portion of the exterior surface of the cell enclosure is anodized.

13. The prismatic battery cell of claim 12, wherein the exterior surface of the second end of the at least one side wall is un-anodized and wherein the un-anodized second end of the at least one side wall is mated to the top cap by laser welding.

14. The prismatic battery cell of claim 9, wherein the top cap is formed of aluminum and a center of the top cap is anodized, wherein an edge of the top cap is un-anodized, and wherein the un-anodized edge of the top cap is mated to the at least one side wall by laser welding.

15. A method for anodizing a cell enclosure, the method comprising:
forming a cell can for the cell enclosure, the cell enclosure including:
at least one side wall including a first end and a second end opposing the first end;
a bottom wall connected to the first end of the at least one side wall defining a volume, an interior surface of the cell enclosure, and an exterior surface of the cell enclosure; and
a top cap mate-able to the second end of the at least one side wall, and
wherein at least one of the at least one side wall, the bottom wall, and the top cap is formed of aluminum and anodized;
covering a portion of the cell enclosure with an acid; and
applying a power source to the cell enclosure, anodizing the covered portion of the cell enclosure.

16. The method of claim 15, wherein covering a portion of the exterior surface of the cell enclosure with the acid, wherein the exterior surface is formed of aluminum and the portion of the exterior surface is anodized.

17. The method of claim 16, wherein covering a portion of the interior surface of the cell enclosure comprises filling the volume defined by the cell enclosure with the acid, wherein the interior surface is formed of aluminum and the portion of the interior surface is anodized.

18. The method of claim 15, further comprising masking a portion of the cell enclosure prior to covering the portion of the cell enclosure with the acid.

19. The method of claim 18, wherein masking includes masking an edge of the top cap and anodizing a center of the top cap, wherein the top cap is formed of aluminum, wherein the edge of the top cap is un-anodized, and further comprising removing the masking and welding the un-anodized edge of the top cap to the at least one side wall of the cell enclosure.

20. The method of claim 18, further comprising removing any masking from the portion of the cell enclosure and welding the top cap to the at least one side wall.
